(19) United States
(12) Patent Application Publication
(10) Pub. No.: US 2008/0259908 A1
(43) Pub. Date: Oct. 23, 2008

(54) Location object proxy

(76) Inventors: John Gordon Hines, Kirkland, WA (US); Darrin Johnson, Monroe, WA (US); Jonathan A. Croy, Seattle, WA (US)

Correspondence Address: MANELLI DENISON & SELTER PLLC, 7th Floor, 2000 M Street, N.W., Washington, DC, 20036-3307, US

(21) Appl. No.: 11/902,846

(22) Filed: Sep. 26, 2007

Related U.S. Application Data
(60) Provisional application No. 60/847,124, filed on Sep. 26, 2006.
(60) Provisional application No. 60/904,434, filed on Mar. 2, 2007.

(51) Int. Cl. H04L 12/66

(52) U.S. Cl. 370/352

(57) ABSTRACT

The function of determination of location is separated from the function of gathering information based on determined location by use of a Location Object (LO) proxy between an initiating VoIP capable device and a positioning center. The LOProxy queries an appropriate location database using a location key, and injects a PIDF-LO into a routing SIP message otherwise without location. A SIP request without location is received from a VoIP capable device. The SIP request contains messages indicating the type of location generator or service needed. A location key (like a telephone number or SIP URI), in addition to the type of location generator or service needed, is included in a SIP request. A location object (LO) broker may be used between a routing SIP message and a positioning center to direct a routing SIP message to an appropriate one of a plurality of location object (LO) proxies.

### BACKGROUND OF THE INVENTION

1. Field of the Invention

This invention relates generally to communications networks. More particularly, it relates to telecommunications networks including Voice Over Internet Protocol (VoIP) network communications, as well as to the provision of location based services (LBS).

2. Background of the Related Art

Session Initiation Protocol (SIP) is a basic protocol for initiating interactive communication sessions (e.g., voice, video, chat, interactive games, virtual reality, etc.) between users. In given SIP-based applications, location of a particular wireless device is desired or required.

Currently, location and other caller-related data for the majority of calls (VoIP, cellular, or landline) is delivered or determined through multiple mechanisms. For instance, location and other data for the majority of calls is determined via the use of a unique query key (such as the telephone number or uniform resource identifier (URI)) to perform a database lookup. In these architectures, the unique query key (e.g., telephone number or URI) is used as a lookup element to query provisioned, staged or static information (e.g., from a suitable database) outside of the actual call signaling for location information.

FIG. 5 shows a conventional exemplary Voice over Internet Protocol (VoIP) based routing architecture for a given Session Initiation Protocol (SIP) message.

In particular, as shown in FIG. 5, a Session Internet Protocol (SIP) message includes a unique query key, or location key (e.g., telephone number or URI) to be used to determine an action based on the initiator's location (i.e., position). As shown in FIG. 5, the SIP message including the unique query (e.g., location) key is passed to a positioning center 502.

Using the received location key, the positioning center 502 passes a query to an appropriate database 504, e.g., a database associating static location with various location key information. The static location database 504 determines the desired location information relating to the input location key, and returns the static location to the requesting positioning center 502.

Then, having obtained appropriate location information, the positioning center 502 passes a request to another database, e.g., a routing database 506, to obtain routing information associated with the received location information. The routing database 506 outputs appropriate routing information to the requesting positioning center 502. At that point, the positioning center 502 passes on the SIP message together with new routing information obtained from the routing database 506.

Accordingly, an entity that wants to route calls and perform other actions based on a caller's location must first build interfaces to the many disparate services and servers. Thus, existing technology places the burden of determining and supporting multiple interfaces to various position determination technologies on all entities that want position information relating to a given caller.

The present inventors have appreciated that such existing solutions make it cumbersome to un-bundle the two functions of (1) determining location; and (2) of gathering desired information to be used based on the determined location (e.g., routing instructions for 9-1-1 calls determined based on the determined location).

### SUMMARY OF THE INVENTION

In accordance with the principles of the current invention, apparatus and method for injecting a location object into a routing SIP message is provided, comprising a location object proxy to receive a SIP message being routed toward a positioning center. A location generator queries an appropriate location database and determine in response a location of an initiator of the SIP message. The location object proxy injects a location object relating to the determined location into the SIP message, the SIP message then continuing toward the positioning center.

Moreover, a method for injecting a location object into a routing SIP message comprises receiving a SIP message being routed toward a positioning center at a location object proxy. An appropriate location database is queried using a location generator, and a location of an initiator of the SIP message is received in response. The location object proxy injects a location object relating to the determined location into the SIP message. The SIP message then continues toward the positioning center.

### BRIEF DESCRIPTION OF THE DRAWINGS

Features and advantages of the present invention will become apparent to those skilled in the art from the following description with reference to the drawings which:

FIG. 1A depicts the insertion of an LO Proxy to separate functions of determining location from the function of gathering information based on determined location, in accordance with the principles of the present invention.

FIG. 1B shows an exemplary embodiment of a location proxy architecture including a location proxy broker, which provides determination of a correct LO proxy for a given received SIP message, to handle emergency services requests, in accordance with the principles of the present invention.

FIG. 2 shows that after the location is added to the SIP message, any positioning center may be chosen to send the SIP Invite to.

FIG. 3 shows an exemplary VoIP based commercial architecture including location determination and the use of that location by an application program, in accordance with the principles of another embodiment of the invention.

FIG. 4 shows that after the location is added to the SIP message, the signaling may touch a number of applications depending on the initial requested service.

FIG. 5 shows a conventional exemplary Voice over Internet Protocol (VoIP) based routing architecture.

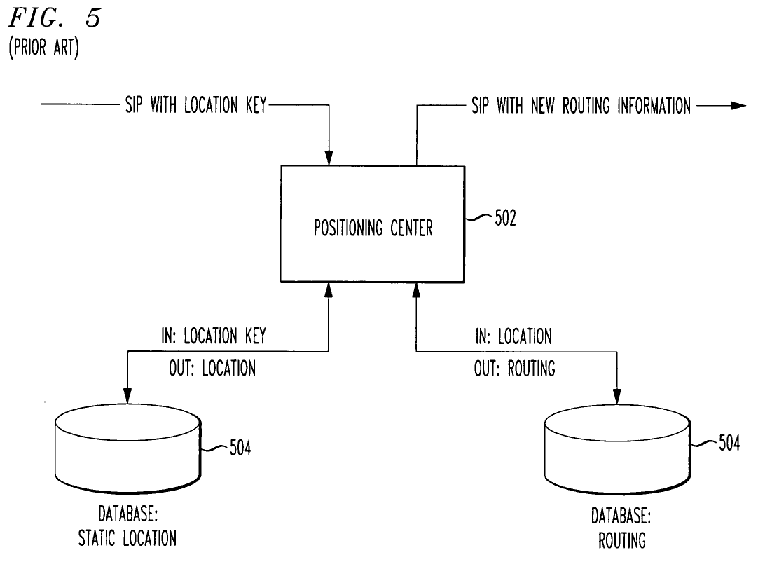

### DETAILED DESCRIPTION OF ILLUSTRATIVE EMBODIMENTS

The present invention provides mechanisms for a mobile device's position to be added on the fly to a Session Initiation Protocol (SIP) message, providing a clearing house to add position to SIP regardless of the various technologies being used.

More particularly, in accordance with the principles of the current invention, a process for adding standard PIDF-LO data elements to SIP messages comprises receiving an inbound SIP message without location. A SIP request without location is received from a VoIP capable device. The SIP request contains messages indicating the type of location generator or service needed. Using a Location Key (like a Telephone Number or SIP URI) in addition to the type of location generator or service needed, a PIDF-LO (LO) is added to the SIP request.

The present invention reduces costs of implementation of downstream servers because those downstream servers need not then implement or reinvent interfacing with each of multiple position determination technologies.

Preferably location information is defined in the presence-based GEOPRIV location object format, which describes an object format for carrying geographical information on the Internet. This location object extends the presence information data format (PIDF), which was designed for communicating privacy-sensitive presence information and which has similar properties. The presence information data format location object (PIDF-LO) specification provides a flexible and versatile means to represent location information.

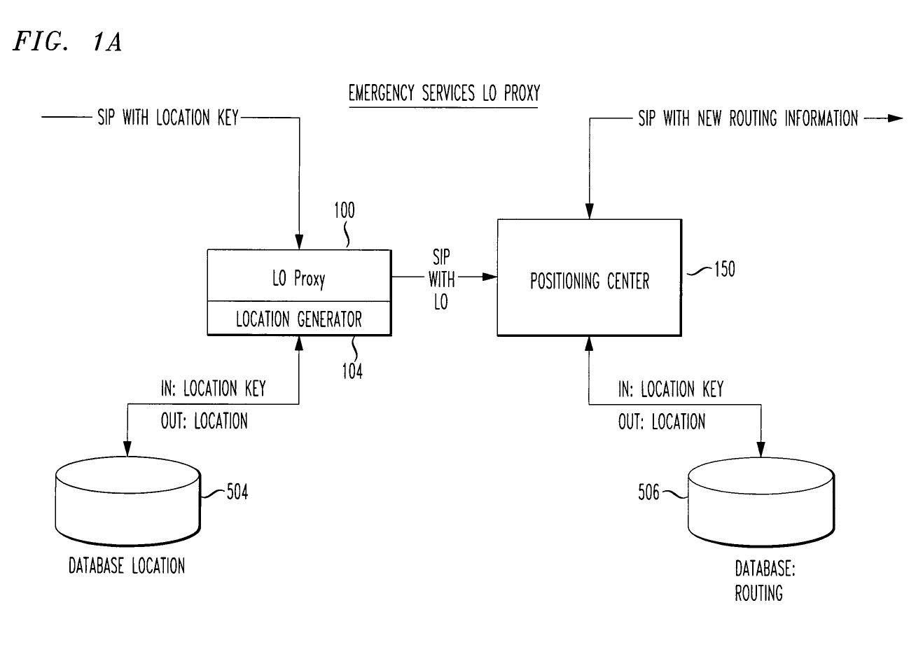

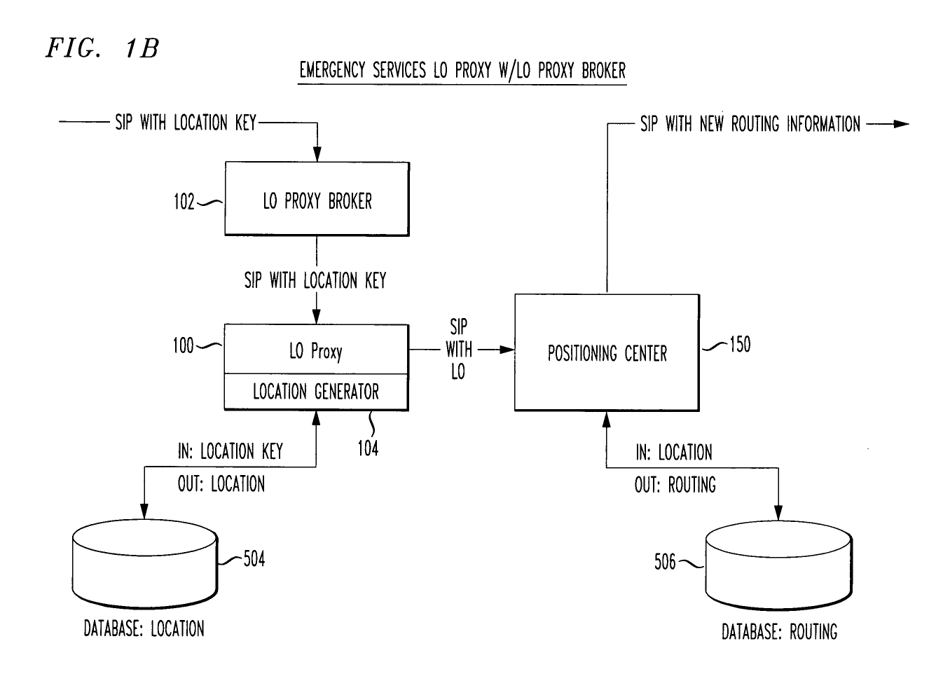

FIG. 1A depicts the insertion of an LO Proxy to separate functions of determining location from the function of gathering information based on determined location, in accordance with the principles of the present invention.

In particular, as shown in FIG. 1A, a location object (LO) proxy 100 and location generator 104 is inserted in a path between an incoming SIP message including a unique query key (e.g., a telephone number or uniform resource identifier (URI)) and a positioning center 150.

In accordance with the invention, location is queried by the location generator 104 instead of being a required function of the positioning center 150. In this way, the function of determination of location (handled by the location object (LO) proxy 100 and location generator 104) is separated from the function of gathering desired information to be used based on the determined location (e.g., routing instructions for 9-1-1 calls determined based on the determined location), handled by the positioning center 150.

The location object (LO) proxy 100 attaches the location object (LO) to the request, and forwards the same to an appropriate positioning center 150 (e.g., a VoIP processing center (VPC)).

The disclosed embodiments provide that as new location determination systems or services are defined, only an appropriate location object (LO) proxy 100 need be implemented to receive and query those systems or services based on a unique set of information delivered specific to that location determination technology. The location information system (LIS) as described above is one of those systems. In the LIS example, the LO proxy 100 receives a query key that is used by the LO proxy 100 to query a pre-provisioned database for the latitude and longitude of the provisioned address.

Other location services and systems can be implemented in the same manner where the data and structure of the data varies as appropriate for the LO proxy 100 to interface with the service or system delivering location information.

FIG. 1B shows an exemplary embodiment of a location proxy architecture including a location proxy broker, which provides determination of a correct LO proxy for a given received SIP message, to handle emergency services requests, in accordance with the principles of the present invention.

In particular, as shown in the embodiment of FIG. 1B, a location object (LO) proxy broker (LOPB) 102 is inserted between the incoming SIP messages and the LO proxy 100.

As shown in FIG. 1B, two major components are provided to separate location based services (LBS) functions of determining location, and gathering information relating to the determined location: a location object proxy broker (LOPB) 102, and a location object proxy 100 (with location generator 104).

The location object proxy broker (LOPB) 102 determines the appropriate LO proxy 100 to use (only one LO proxy is shown in FIG. 1B).

The LO proxy 100 attaches a location object to the request (i.e., SIP with location key) and forwards the same to an engine (e.g., positioning center 150) that uses location to determine and return additional information (like routing information for a 911 call, routing information for commercial applications, etc).

The disclosed embodiments further provide that as new location determination systems or services are defined, data elements and the structure of that data in the initial SIP INVITE can be defined to query those systems or services for location information. To this end, a location object (LO) proxy broker 102 is implemented in front of the LO proxy (or proxies) 100.

The LO proxy broker 102 comprises logic (software and/or hardware) that enables it to evaluate the data elements and structure sent in the initial SIP INVITE to determine the appropriate LO Proxy 100 to send the INVITE to.

The Location Object (LO) proxy broker 102 acts like a router for a set of LO proxies 100, where the data included in the messaging indicates to which LO proxy 100 the SIP INVITE should be sent.

In operation, a User Endpoint (UE) initiates a SIP INVITE message including a unique location key (and/or other specific set of information in a predetermined location) in the SIP INVITE.

The INVITE is sent to the location object proxy broker (LOPB) 102 where the LOPB 102 evaluates key elements to determine which LO proxy 100 supports the technology to determine the location.

After the correct LO proxy 100 is determined, the LOPB 102 forwards the INVITE.

The LO proxy 100 receives the SIP INVITE from the LOPB 102 and uses key elements in the SIP INVITE to query a database, e.g., location database 504, or service to determine location.

Upon receipt of the location, the LO proxy 100 rewrites the SIP INVITE to include location.

The LO proxy 100 then forwards the SIP INVITE through the SIP network, presumably to an entity that will make use of the location.

For example, let's take a user endpoint (UE) that is a Voice Over IP (VoIP) phone, a pre-provisioned address in a database (e.g., a location information system), and a user that dials 911 (or other designated emergency call number) on the VoIP phone.

The SIP INVITE from the VoIP phone will contain a unique key (the URI for example) that is forwarded on to the LOPB 102. The LOPB 102 evaluates the SIP message with the unique key (the caller URI for example) and determines that the SIP INVITE should be routed to the LO proxy (e.g., LO proxy 100) that handles location information system (LIS) requests using a URI.

The LOPB 102 sends the SIP INVITE on to the location information system (LIS) LO proxy 100. The location information system (LIS) LO proxy 100 is a specific implementation of the LO proxy able to handle requests for LIS queries.

The LIS LO proxy 100 queries the LIS and receives location information back.

Once received, the SIP INVITE is rewritten with the location in a PIDF-LO in the SIP message, and is then forwarded on to a PDIF-LO enabled VoIP processing center (VPC) (e.g., positioning center 150) for determination of the appropriate emergency call center (e.g., appropriate Public Safety Access Point (PSAP) that the emergency call should be routed to.

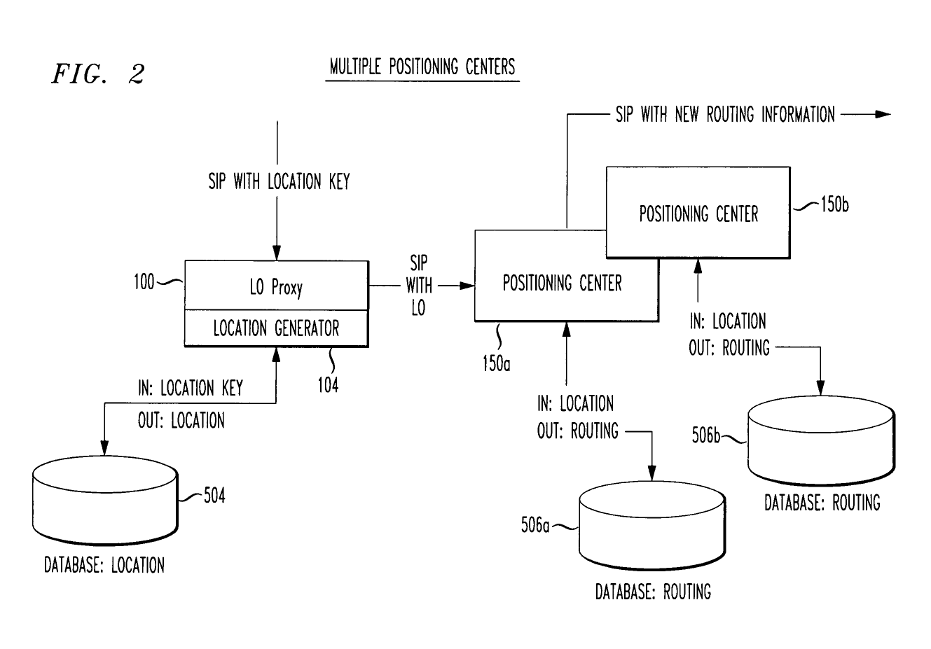

FIG. 2 shows that after the location is added to the SIP message, any positioning center may be chosen to send the SIP Invite to.

In particular, as shown in FIG. 2, the SIP message with location object included may be forwarded to any (or all) of a plurality of appropriate positioning centers 150a, 150b.

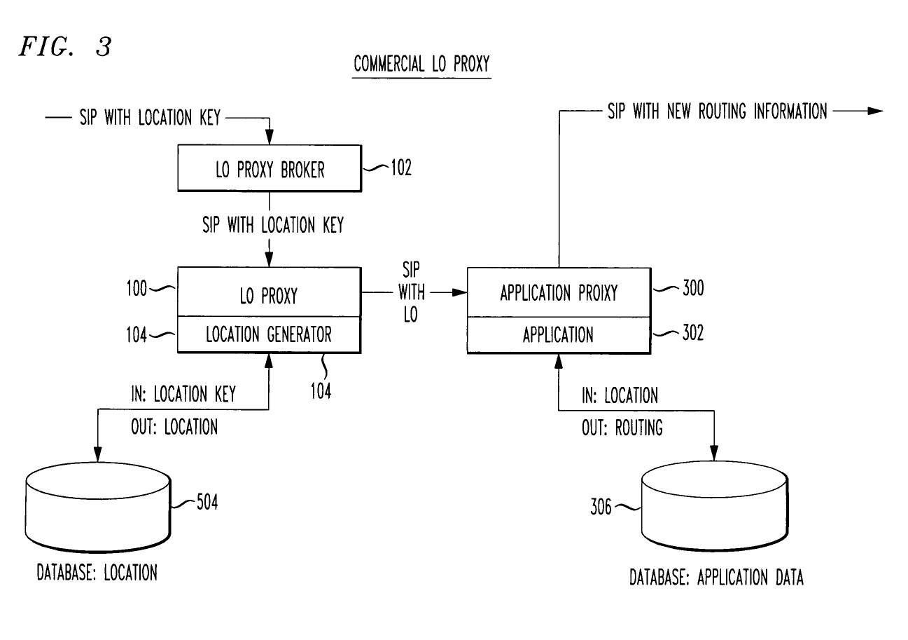

FIG. 3 shows an exemplary VoIP based commercial architecture including location determination and the use of that location by an application program, in accordance with the principles of another embodiment of the invention.

In particular, as shown in FIG. 3, instead of the positioning center(s) 150 shown in FIGS. 1 and 2, the entity that handles the newly-separated secondary function of gathering information based on determined location is an application program 302, including an associated application proxy 300.

The application program 302 may be any desired application that utilizes location information received from the LO proxy 100, e.g., in a SIP with location object (LO) message.

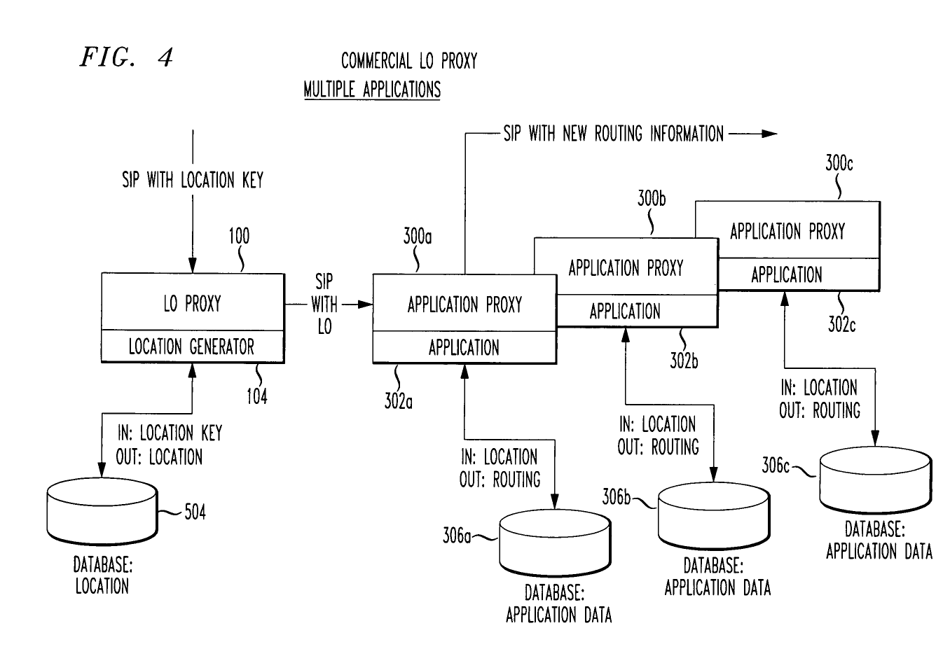

FIG. 4 shows that after the location is added to the SIP message, the signaling may touch a number of applications depending on the initial requested service. For instance, as depicted in FIG. 4, any number of application programs 302a-302c (with associated application proxies 300a-300c) may receive the SIP with LO message packaged by the LO proxy 100, in accordance with the principles of the present invention.

Thus, as is described in detailed embodiments herein, a location object proxy broker 102 in accordance with the principles of the invention separates location determination from instructions for call processing once location is determined. Also, the present invention enables a common presentation of location in SIP messaging for a location driven engine, examples being a VoIP Positioning Center (VPC) 150 or an application program 302.

Those that may make particular use of the invention include any/all communications users, including voice over IP (VoIP), wireless and/or landline users, as well as VoIP service providers.

While the invention has been described with reference to the exemplary embodiments thereof, those skilled in the art will be able to make various modifications to the described embodiments of the invention without departing from the true spirit and scope of the invention.

What is claimed is:

1. Apparatus for injecting a location object into a routing SIP message, comprising:
a location object proxy to receive a SIP message being routed toward a positioning center; and
a location generator to query an appropriate location database and determine in response a location of an initiator of said SIP message;
wherein said location object proxy injects a location object relating to said determined location into said SIP message, said SIP message then continuing toward said positioning center.

2. The apparatus for injecting a location object into a routing SIP message according to claim 1, wherein said positioning center comprises:
a VoIP positioning center (VPC).

3. The apparatus for injecting a location object into a routing SIP message according to claim 1, wherein said location generator comprises:
means for querying a database with a unique location key; and
means for receiving in response a location of an initiator of said SIP message.

4. The apparatus for injecting a location object into a routing SIP message according to claim 3, wherein said database comprises:
a static location database.

5. The apparatus for injecting a location object into a routing SIP message according to claim 3, wherein said unique location key comprises:
a telephone number.

6. The apparatus for injecting a location object into a routing SIP message according to claim 3, wherein said unique location key comprises:
a uniform resource identifier (URI).

7. A method for injecting a location object into a routing SIP message, comprising:
receiving a SIP message being routed toward a positioning center at a location object proxy; and
querying an appropriate location database using a location generator, and receiving in response a location of an initiator of said SIP message;
wherein said location object proxy injects a location object relating to said determined location into said SIP message, said SIP message then continuing toward said positioning center.

8. The method for injecting a location object into a routing SIP message according to claim 7, wherein said positioning center comprises:
a VoIP positioning center (VPC).

9. The method for injecting a location object into a routing SIP message according to claim 7, wherein said querying comprises:
querying a database with a unique location key; and
receiving in response a location of an initiator of said SIP message.

10. The method for injecting a location object into a routing SIP message according to claim 9, wherein said database comprises:
a static location database.

11. The method for injecting a location object into a routing SIP message according to claim 9, wherein said unique location key comprises:
a telephone number.

12. The method for injecting a location object into a routing SIP message according to claim 9, wherein said unique location key comprises:
a uniform resource identifier (URI).
